(19) United States
(12) Patent Application Publication
(10) Pub. No.: US 2018/0009089 A1
(43) Pub. Date: Jan. 11, 2018

(54) HEXALOBULAR FASTENER DRIVE TOOL WITH SHROUD

(71) Applicant: FORD GLOBAL TECHNOLOGIES, LLC, Dearborn, MI (US)

(72) Inventors: Jay Robert Degenkolb, Rockwood, MI (US); Eric Emil Jackson, Canton, MI (US)

(21) Appl. No.: 15/207,113

(22) Filed: Jul. 11, 2016

(51) Int. Cl. B25B 15/00; F16B 35/06; B25B 23/08

(52) U.S. Cl. CPC B25B 15/005; B25B 23/08; F16B 35/06

(57) ABSTRACT

A fastener drive tool includes a hexalobular drive bit and a shroud concentrically disposed about the hexalobular drive bit. In addition, a fastener driving arrangement includes a screw fastener having a drive head with a cavity defined by a hexalobular sidewall. The fastener driving arrangement also includes a fastener drive tool including a hexalobular drive bit received in the cavity and a shroud received concentrically around the drive head of the screw fastener.

### TECHNICAL FIELD

This document relates generally to the field of fastening workpieces together and, more particularly, a fastener drive tool and a fastener driving arrangement incorporating a hexalobular drive bit and a shroud concentrically disposed about the hexalobular drive bit in order to resist the drive tool from camming out of the head of the fastener as the fastener is tightened or loosened.

### BACKGROUND

A number of different screw fasteners have been developed for securing two or more workpieces together. Such screw fasteners include various drive head arrangements. Examples of these include Phillips head and slot head screws. Both Phillips head and slot head screws were designed to cause the fastener drive tool to cam out of the drive cavity provided in the head of the fastener in order to prevent over-tightening of the fastener.

An additional type of screw fastener incorporates a hexalobular shaped cavity specifically designed to prevent a fastener drive tool from camming out during the tightening or loosening process. Such a fastener is sold under the TORX trademark.

While a screw fastener incorporating a hexalobular drive cavity is substantially more resistant to camming out than such a fastener incorporating a Phillips head or a slot head, a fastener drive tool attached to a power tool such as a pneumatic wrench or an electrical drill still tends to jump out of the hexalobular drive cavity once the fastener is seated. This may lead to the hexalobular drive bit at the end of the fastener drive tool coming into contact with the surrounding surfaces of the workpiece leaving undesired blemishes or scratches.

This document relates to a new and improved fastener drive tool incorporating a shroud that is concentrically disposed around the hexalobular drive bit. That shroud functions to better maintain the drive tool and, more particularly, the hexalobular drive bit of the drive tool within the hexalobular drive cavity in the head of the fastener thereby reducing or eliminating the problem of blemishes that might otherwise be caused by the drive tool jumping out from proper engagement with the fastener.

### SUMMARY

In accordance with the purposes and benefits described herein, a fastener drive tool is provided. That fastener drive tool comprises a hexalobular drive bit and a shroud concentrically disposed about the hexalobular drive bit.

The fastener drive tool may further include a socket drive section. That socket drive section may include a sidewall defining a bore having an acircular cross-section. In one possible embodiment, the socket drive section includes a sidewall defining a bore having a square cross-section.

In one possible embodiment of the fastener drive tool, the shroud and the socket drive section are integrally formed as a single part.

In one possible embodiment the hexalobular drive bit has a first length L1 and the shroud has a second length L2 where L1>L2. Still further, the hexalobular drive bit has a first distal end and the shroud has a second distal end wherein the first distal end projects past the second distal end.

In one of many possible embodiments, the shroud snaps onto the socket drive section. More specifically, an annular end wall of the shroud abuts against a mounting shoulder formed in the sidewall of the socket drive section. In accordance with still another aspect, a fastener driving arrangement is provided. That fastener driving arrangement comprises a screw fastener including a drive head with a cavity defined by a hexalobular sidewall and a fastener drive tool including a hexalobular drive bit received in the cavity and a shroud received concentrically around the drive head of the screw fastener.

In the following description, there are shown and described several preferred embodiments of the fastener drive tool and the fastener driving arrangement. As it should be realized, the drive tool and the fastener driving arrangement are capable of other, different embodiments and their several details are capable of modification in various, obvious aspects all without departing from the fastener drive tool and fastener driving arrangement as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the fastener drive tool and the fastener driving arrangement and together with the description serve to explain certain principles thereof. In the drawing figures:

FIG. 1 is a perspective view of the fastener drive tool incorporating a hexalobular drive bit and a shroud concentrically disposed about the hexalobular drive bit.

FIG. 2 is a distal end view of the fastener drive tool illustrated in FIG. 1.

FIG. 3 is a cross-sectional view of the fastener drive tool illustrated in FIGS. 1 and 2.

FIG. 4 is an exploded cross-sectional view of a fastener driving arrangement incorporating the fastener drive tool illustrated in FIGS. 1-3 and a screw fastener including a drive head with a cavity defined by a hexalobular sidewall.

FIG. 5 is a cross-sectional view illustrating how the fastener driving arrangement is utilized to secure two workpieces together while maintaining the fastener drive tool in proper engagement with the screw fastener as the screw fastener is fully seated to join the two workpieces.

FIG. 6 is a cross-sectional view of a modified embodiment of the fastener tool including a snap on shroud.

Reference will now be made in detail to the present preferred embodiments of the fastener drive tool and fastener driving arrangement, examples of which are illustrated in the accompanying drawing figures.

### DETAILED DESCRIPTION

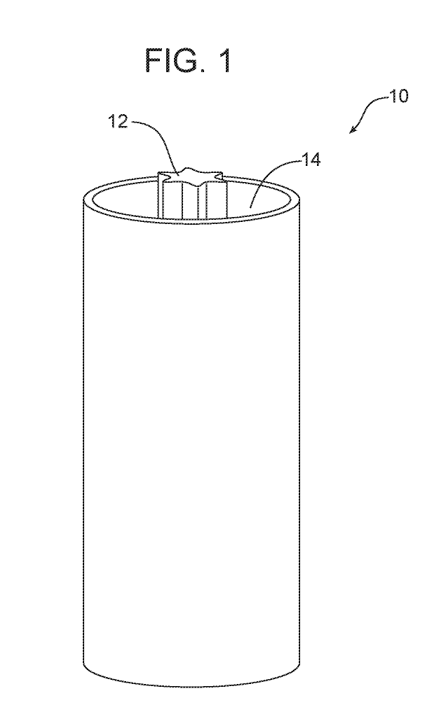

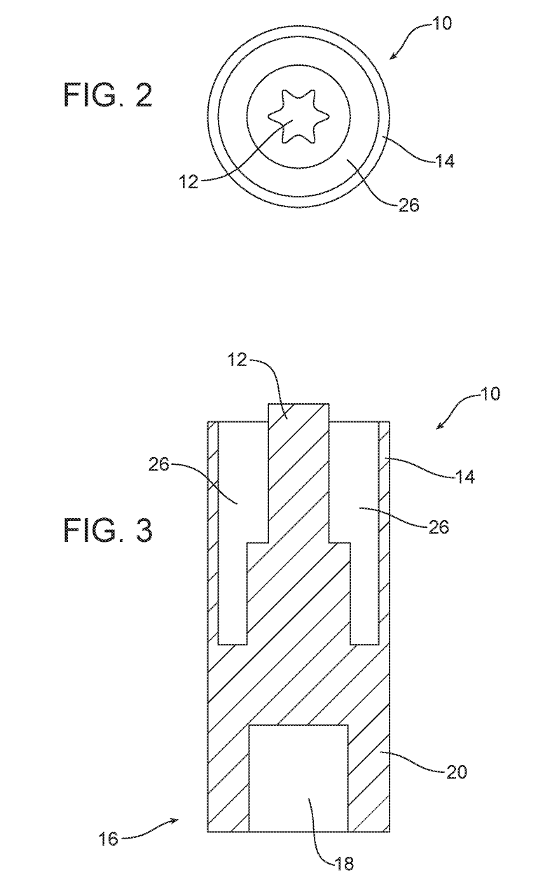

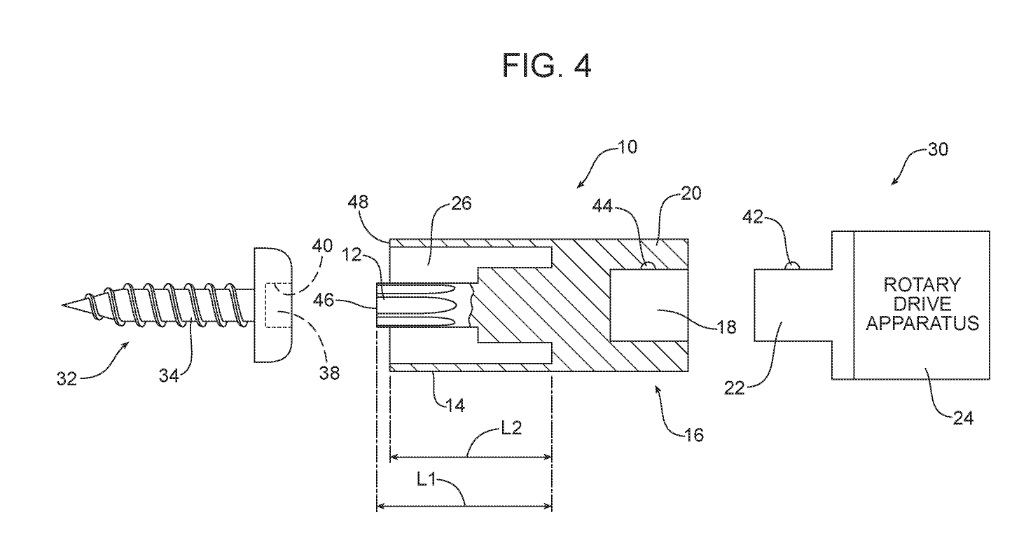

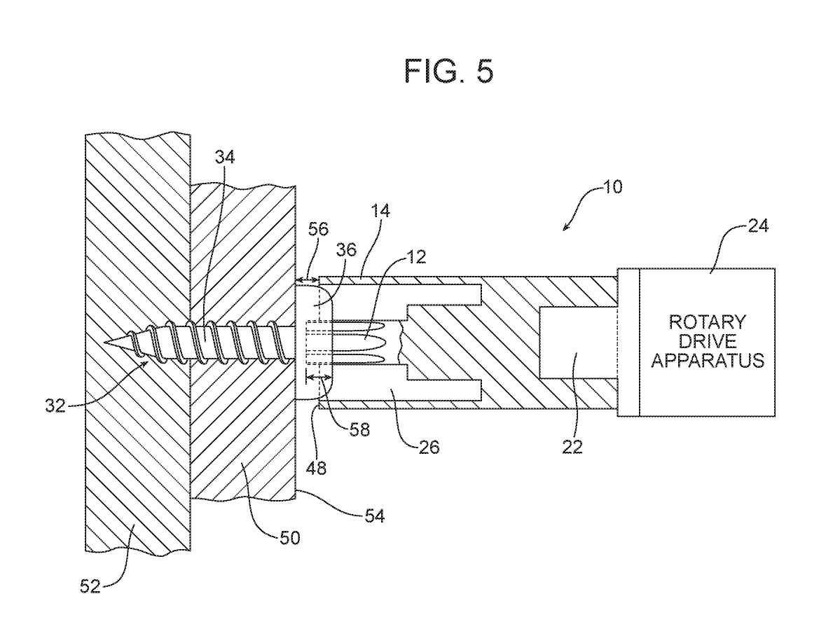

Reference is now made to FIGS. 1-3 illustrating the fastener drive tool 10. The fastener drive tool 10 includes a drive bit 12 with a hexalobular cross-section and a shroud 14 concentrically disposed about the hexalobular drive bit. In addition, the fastener drive tool 10 includes a socket drive section 16. The socket drive section 16 includes a blind bore 18 within a sidewall 20 defining an acircular cross-section. In the illustrated embodiment, that sidewall 20 defines a square cross-section for receiving the drive stud 22 of a drive apparatus such as a powered rotary drive apparatus 24 (see also FIGS. 4 and 5). Such a powered rotary drive apparatus 24 may, for example, comprise an impact wrench or a drill under manual or robotic control.

In the illustrated embodiment, the shroud 14 and the socket drive section 16 are integral and made as a single, one-piece component. In addition, a cavity 26 is formed between the hexalobular drive bit 12 and the shroud 14.

Reference is now made to FIG. 4 which is an exploded perspective view of a fastener driving arrangement 30. That fastener driving arrangement 30 comprises a screw fastener 32 and the fastener drive tool 10 illustrated in FIGS. 1-3.

More specifically, the screw fastener 32 comprises a threaded shank 34 and a drive head 36. The drive head 36 includes a cavity 38 defined by a hexalobular sidewall 40.

As illustrated in FIG. 4, the fastener drive tool 10 is attached to the drive stud 22 of the rotary drive apparatus 24 by positioning the socket drive section 16 thereof over the drive stud 22 so that the drive stud is received in the bore 18 in engagement with the sidewall 20. A spring-loaded detent 42 may be provided on the drive stud 22. That detent 42 may be received in a receiver 44 in the sidewall 20 in order to secure the connection of the fastener drive tool 10 on the drive stud 22 of the rotary drive apparatus 24.

The fastener drive tool 10 is connected to the screw fastener 32 by aligning the drive bit 12 with the cavity 38 in the drive head 36. Here it should be noted that the hexalobular drive bit 12 has a first length L1 while the shroud 14 has a second length L2 where L1>L2. Thus, as illustrated in FIG. 4, the hexalobular drive bit 12 has a first distal end 46 that projects past the second distal end 48 of the shroud 14.

The cavity 38 in the drive head 36 is sized and shaped to correspond to the drive bit 12 so that the drive bit 12 nests snugly in the cavity 38. Similarly, the cavity 26 between the drive bit 12 and the shroud 14 is sized to accommodate the drive head 36 so that when the drive bit 12 is fully seated in the cavity 38 of the drive head 36, the shroud 14 is concentrically received around the drive head. See FIG. 5. As should be appreciated, the shroud 14 actually aids in aligning and connecting the fastener drive tool 10 to the drive head 36 of the screw fastener 32.

FIG. 5 shows the rotary drive apparatus 24 connected to the fastener drive tool 10 and the fastener drive tool 10 connected to the screw fastener 32. As illustrated, the screw fastener has been fully seated to secure the first workpiece 50 with the second workpiece 52. As should be appreciated, when in this fully seated position, the distal end 48 of the shroud 14 is spaced just slightly from the surface 54 of the first workpiece 50. The clearance space 56 between the distal end 48 of the shroud 14 and the surface of the first workpiece 50 is less than the depth 58 of engagement of the drive bit 12 in the cavity 38 in the drive head 36. Thus, the shroud 14 aids in preventing the drive bit 12 from jumping out of the cavity 38 and the fastener drive tool 10 from becoming disengaged from the screw fastener 32. Accordingly, the fastener drive tool 10 is effective to prevent inadvertent engaging and blemishing of the surface 54 of the first workpiece 50.

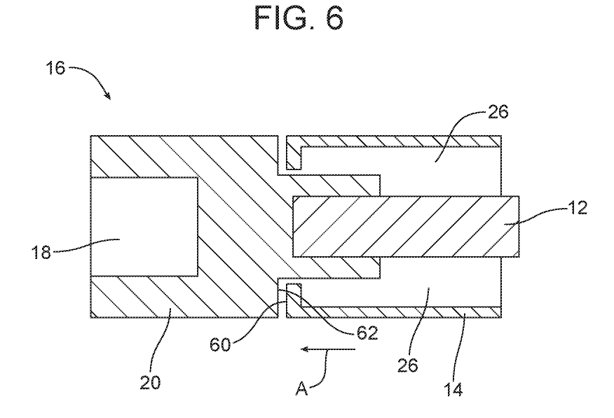

As illustrated in FIG. 6, fastener drive tool 10 may be modified so as to include a snap on shroud 14 having an annular end wall 60 that abuts against a shoulder 62 in the sidewall 20 (note action arrow A indicating installation/connection) when the shroud is connected to the socket drive section 16. The foregoing has been presented for purposes of illustration and description. It is not intended to be exhaustive or to limit the embodiments to the precise form disclosed. Obvious modifications and variations are possible in light of the above teachings. For example, the fastener drive tool may be modified to include a flathead drive bit, a Phillips head drive bit or other style or type of drive bit. All such modifications and variations are within the scope of the appended claims when interpreted in accordance with the breadth to which they are fairly, legally and equitably entitled.

1. (canceled)

2. (canceled)

3. The fastener drive tool of claim 10, wherein said socket drive section includes a sidewall defining a bore with a square cross-section.

4. The fastener drive tool of claim 10, wherein said shroud and said socket drive section are integral.

5. (canceled)

6. The fastener drive tool of claim 10, wherein said hexalobular drive bit has a first distal end and said shroud has a second distal end wherein said first distal end projects past said second distal end.

7. The fastener drive tool of claim 3 wherein said sidewall includes a shoulder and said shroud includes an annular end wall that abuts said shoulder when said shroud is secured to said socket drive section.

8. (canceled)

9. (canceled)

10. A fastener drive tool, comprising:
a hexalobular drive bit:
a shroud concentrically disposed about said hexalobular drive bit; and
a socket drive section wherein said shroud and said socket drive section are a single, one-piece component and said hexalobular drive bit is fixed to said socket drive section.

11. The fastener drive tool of claim 10 wherein said hexalobular drive bit, said shroud and said socket drive section are a single, one-piece component.
